(19) United States
(12) Patent Application Publication
(10) Pub. No.: US 2025/0056510 A1
(43) Pub. Date: Feb. 13, 2025

(54) TRIGGERING ON-DEMAND SSB OR SIB1

(71) Applicant: Samsung Electronics Co., Ltd., Suwon-si (KR)

(72) Inventors: Hongbo Si, Allen, TX (US); Anil Agiwal, Allen, TX (US); Jeongho Jeon, San Jose, CA (US)

(21) Appl. No.: 18/786,405

(22) Filed: Jul. 26, 2024

Related U.S. Application Data
(60) Provisional application No. 63/531,973, filed on Aug. 10, 2023.
(60) Provisional application No. 63/531,978, filed on Aug. 10, 2023.
(60) Provisional application No. 63/553,296, filed on Feb. 14, 2024.
(60) Provisional application No. 63/575,235, filed on Apr. 5, 2024.

(51) Int. Cl. H04W 72/0446; H04W 56/00

(52) U.S. Cl. CPC H04W 72/0446; H04W 56/00

(57) ABSTRACT

Methods and apparatuses for an operation for triggering on-demand synchronous signal/physical broadcast channel block (SSB) or a system information block 1 (SIB1) in a wireless communication system. A method of a user equipment (UE) in a wireless communication system includes receiving a first physical downlink shared channel (PDSCH) from a base station (BS) and determining, based on an indication in the first PDSCH, that a set of synchronization signals and physical broadcast channel (SS/PBCH) blocks is activated for transmission from the BS. The method further includes determining a time domain offset with respect to the first PDSCH, determining that the set of SS/PBCH blocks is to be transmitted after the time domain offset and receiving a SS/PBCH block in the set of SS/PBCH blocks.

### CROSS-REFERENCE TO RELATED APPLICATIONS AND CLAIM OF PRIORITY

The present application claims priority to:
U.S. Provisional Patent Application No. 63/531,973, filed on Aug. 10, 2023;
U.S. Provisional Patent Application No. 63/531,978, filed on Aug. 10, 2023;
U.S. Provisional Patent Application No. 63/553,296, filed on Feb. 14, 2024; and
U.S. Provisional Patent Application No. 63/575,235, filed on Apr. 5, 2024.

The contents of the above-identified patent documents are incorporated herein by reference.

### TECHNICAL FIELD

The present disclosure relates generally to wireless communication systems and, more specifically, the present disclosure relates to an operation for triggering an on-demand synchronous signal/physical broadcast channel block (SSB) or a system information block 1 (SIB1) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to an operation for triggering on-demand SSB or SIB1 in a wireless communication system.

In one embodiment, a user equipment (UE) in a wireless communication system is provided. The UE includes a transceiver configured to receive a first physical downlink shared channel (PDSCH) from a base station (BS) and a processor operably coupled to the transceiver. The processor is configured to determine, based on an indication in the first PDSCH, that a set of synchronization signals and physical broadcast channel (SS/PBCH) blocks is activated for transmission from the BS; determine a time domain offset with respect to the first PDSCH; and determine that the set of SS/PBCH blocks is to be transmitted after the time domain offset. The transceiver is further configured to receive a SS/PBCH block in the set of SS/PBCH blocks. In another embodiment, a method of a UE in a wireless communication system is provided. The method includes receiving a first PDSCH from a BS and determining, based on an indication in the first PDSCH, that a set of SS/PBCH blocks is activated for transmission from the BS. The method further includes determining a time domain offset with respect to the first PDSCH; determining that the set of SS/PBCH blocks is to be transmitted after the time domain offset; and receiving a SS/PBCH block in the set of SS/PBCH blocks.

In yet another embodiment, a base station (BS) in a wireless communication system is provided. The BS includes a processor configured to determine an indication in a first PDSCH and determine a time domain offset with respect to the first PDSCH. The indication indicates that a set of SS/PBCH blocks is activated for transmission. The BS further includes a transceiver operably coupled to the processor. The transceiver is configured to transmit the first PDSCH to a UE and transmit the set of SS/PBCH blocks after the time domain offset.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of SS/PBCH block structure according to embodiments of the present disclosure;

FIG. 7 illustrates an example of triggering mechanisms for on-demand SSB and/or on-demand SIB1 according to embodiments of the present disclosure;

FIG. 8 illustrates a flowchart of UE method for receiving on-demand SSB and/or on-demand SIB1 according to embodiments of the present disclosure;

FIG. 9 illustrates an example of on-demand SSB/SIB1 according to embodiments of the present disclosure;

FIG. 10 illustrates an example of a transmission window for on-demand SSB/SIB1 according to embodiments of the present disclosure;

FIG. 11 illustrates an example of on-demand SSB/SIB1 transmissions according to embodiments of the present disclosure; and

FIG. 12 illustrates a flowchart of UE method for on-demand SSB/SIB1 reception according to embodiments of the present disclosure.

### DETAILED DESCRIPTION

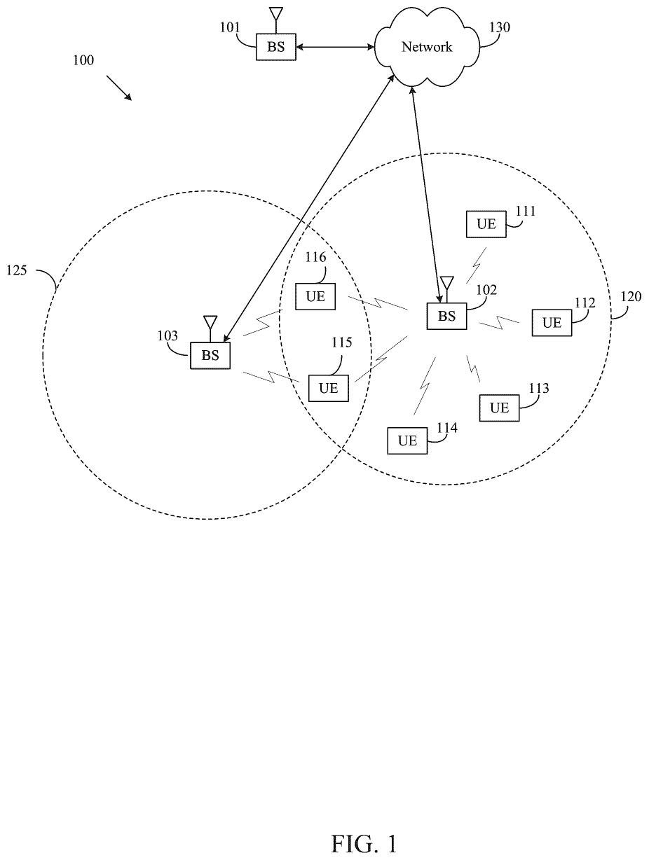

FIGS. 1-12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and channel coding”; 3GPP TS 38.213 v16.1.0, “NR; Physical layer procedures for control”; 3GPP TS 38.214 v16.1.0, “NR; Physical layer procedures for data”; and 3GPP TS 38.331 v16.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an operation for triggering on-demand SSB or SIB1 in a wireless communication system. In certain embodiments, and one or more of the gNBs 101-103 includes circuitry, programing, or a combination thereof, for supporting an operation for triggering on-demand SSB or SIB1 in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

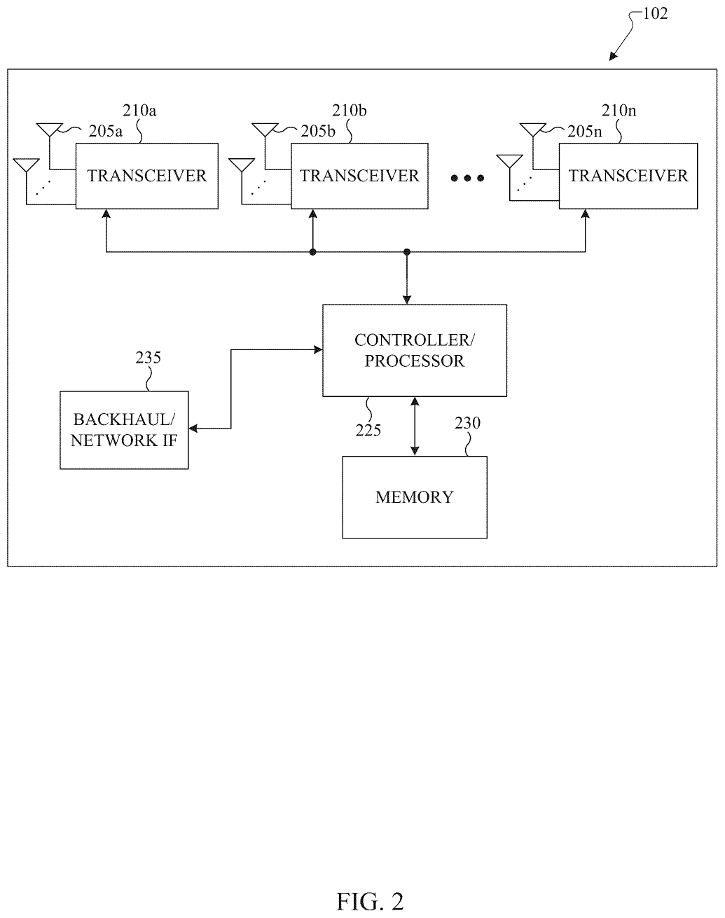

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting an operation for triggering on-demand SSB or SIB1 in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

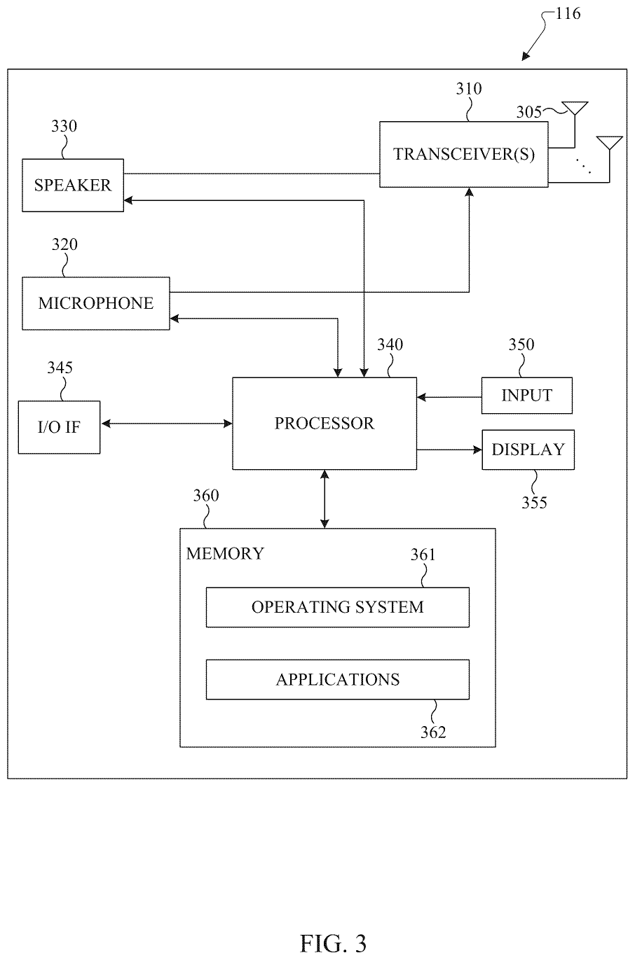

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an operation for triggering on-demand SSB or SIB1 in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The VO interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

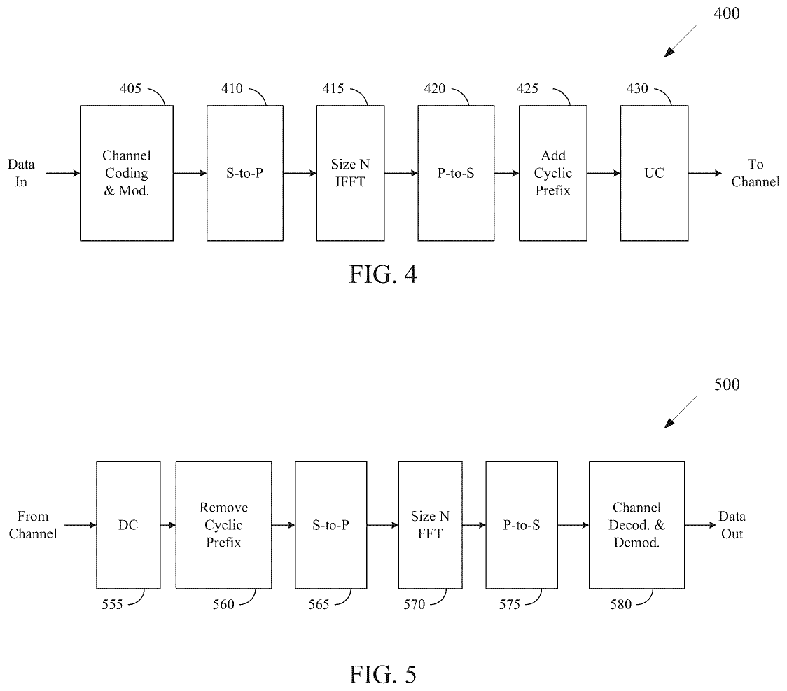

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support an operation for triggering on-demand SSB or SIB1 in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

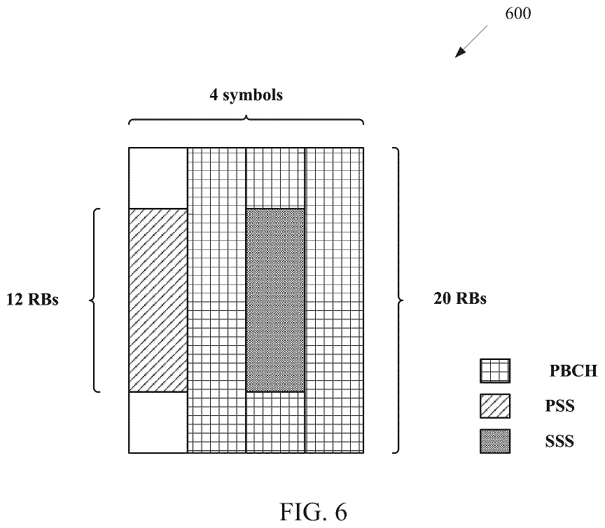

FIG. 6 illustrates an example of SS/PBCH block structure 600 according to embodiments of the present disclosure. An embodiment of the SS/PBCH block structure 600 shown in FIG. 6 is for illustration only.

NR supports synchronization through synchronization signals transmitted on downlink. An SSB compromises of four consecutive OFDM symbols in time domain (e.g., as illustrated in FIG. 6), wherein the first symbol is mapped for primary synchronization signal (PSS), the second and forth symbols are mapped for PBCH, and the third symbol is mapped for both secondary synchronization signal (SSS) and PBCH. The transmission bandwidth of PSS and SSS (e.g., 12 resource blocks (RBs)) is smaller than the transmission bandwidth of the whole SS/PBCH block (e.g., 20 RBs). In every RB mapped for PBCH, 3 out of the 12 resource elements (REs) are mapped for the demodulation reference signal (DMRS) of PBCH, wherein the 3 REs are uniformly distributed in the RB and the starting location of the first RE (e.g., v as in TABLE 1) is based on cell ID.

TABLE 1
Resource mapping within a S-SS/PSBCH block.

| Signal or channel | Symbol index | Subcarrier index |
|---|---|---|
| S-PSS | 0 | 56, 57, . . . , 182 |
| S-SSS | 2 | 56, 57, . . . , 182 |
| Set to | 0 | 0, 1, . . . , 55, 183, |
| zero | | 184, . . . , 239 |
| | 2 | 48, 49, . . . , 55, 183, |
| | | 184, . . . , 191 |
| PSBCH | 1, 3 | 0, 1, . . . , 239 |
| | 2 | 0, 1, . . . , 47, |
| | | 192, 193, . . . , 239 |
| DM-RS | 1, 3 | 0 + ν, 4 + ν, . . . , 236 + ν |
| for PSBCH | 2 | 0 + ν, 4 + ν, . . . , 44 + ν, |
| | | 192 + ν, 196 + ν, . . . , 236 + ν, |

An SS/PBCH block is transmitted on a cell periodically, with a periodicity configured by a gNB. As an always-present transmission, the power consumption for SS/PBCH block in a cell can be significantly large. To reduce the power consumption, the periodicity of SSB can be large, which may result in long delay for receiving the SSB, if a UE needs to receive a SSB on a timing within the long period for SSB. For this purpose, on-demand SSB can be supported, e.g., in addition to the periodic SSB, to reduce the latency for receiving the SSB.

The present disclosure focuses on procedure for triggering on-demand transmission of SSB and/or SIB1. In details, this disclosure includes the following aspects: (1) general procedure for on-demand SSB and/or SIB1; (2) a UL request design: (i) a type of signal or channel, (ii) an indication by the uplink request, (iii) a configuration for the uplink request, and (iv) an application delay or offset for the uplink request; (3) a DL trigger design: (i) a type of signal or channel, (ii) an indication by the downlink trigger, (iii) a configuration for the downlink trigger, and (iv) an application delay or offset for the downlink trigger.

In one embodiment, a set of SS/PBCH block(s) and/or a set of PDCCH/PDSCH for SIB1 can be transmitted by a gNB and/or received by a UE, wherein the transmission and/or reception can be triggered or indicated by an uplink (UL) request and/or a downlink (DL) trigger. For one instance, the set of SS/PBCH block(s) can be denoted as on-demand SSB, or triggered SSB. For another instance, the set of PDCCH/PDSCH for SIB1 can be denoted as on-demand SIB1, or triggered SIB1.

In one example, the on-demand SSB and/or on-demand SIB1 can be supported on a SCell and/or a PSCell, e.g., for a UE in an RRC_CONNECTED mode.

In another example, the on-demand SSB and/or on-demand SIB1 can be supported for a UE in an RRC_IDLE and/or an RRC_INACTIVE mode.

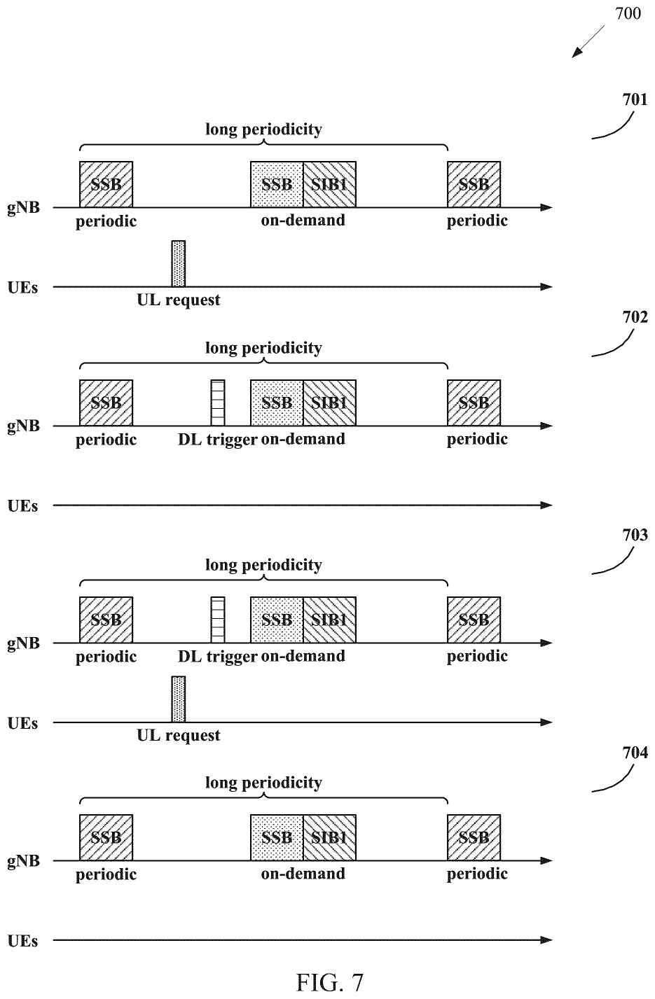

FIG. 7 illustrates an example of triggering mechanisms for on-demand SSB and/or on-demand SIB1 700 according to embodiments of the present disclosure. An embodiment of the triggering mechanisms for on-demand SSB and/or on-demand SIB1 700 shown in FIG. 7 is for illustration only.

In one example (e.g., 701 in FIG. 7), a UE can transmit an uplink request for at least one SSB in a set of SSB(s) and/or at least one PDCCH/PDSCH for SIB1 in a set of PDCCH(s)/PDSCH(s) for SIB1, and the UE can determine a first set of one or multiple reception occasion(s) for the at least one SSB in a set of SSB(s), and/or determine a second set of one or multiple reception occasion(s) for the at least one PDCCH/PDSCH for SIB1 in the set of PDCCH(s)/PDSCH(s) for SIB1, wherein the first set and the second set of reception occasion(s) locate after the transmission of the uplink request. The UE may expect to receive the at least one SSB in the set of SSB(s) in the first set of reception occasion(s), and/or receive the at least one PDCCH/PDSCH for SIB1 in the set of PDCCH(s)/PDSCH(s) for SIB1 in the second set of reception occasion(s).

For this example, the reception of the at least one SSB in the set of SSB(s) and/or the reception of the at least one PDCCH/PDSCH for SIB1 in the set of PDCCH(s)/PDSCH(s) for SIB1 can be considered as a confirmation to the uplink request, and the UE may stop sending the uplink request again. For this example, if the UE did not receive the at least one SSB in the set of SSB(s) and/or the at least one PDCCH/PDSCH for SIB1 in the set of PDCCH(s)/PDSCH(s) for SIB1, e.g., in a window after the transmission of the uplink request or missing the reception for a number of times, the UE may send the uplink request again at another transmission occasion for the uplink request.

In another example (e.g., 702 in FIG. 7), a UE determines a first set of one or multiple reception occasion(s) for a downlink trigger, and/or determine a second set of one or multiple reception occasion(s) for at least one SSB in a set of SSB(s), and/or determine a third set of one or multiple reception occasion(s) for at least one PDCCH/PDSCH for SIB1 in the set of PDCCH(s)/PDSCH(s) for SIB1, wherein the second set and/or third set of reception occasion(s) locate after the first set of reception occasion(s), and the UE may expect to receive the downlink trigger in the first set of reception occasion(s), and/or receive the at least one SSB in the set of SSB(s) in the second set of reception occasion(s), and/or receive the at least one PDCCH/PDSCH for SIB1 in the set of PDCCH(s)/PDSCH(s) for SIB1 in the third set of reception occasion(s).

In yet another example (e.g., 703 in FIG. 7), a UE can transmit an uplink request for at least one SSB in a set of SSB(s) and/or at least one PDCCH/PDSCH for SIB1 in a set of PDCCH(s)/PDSCH(s) for SIB1, and the UE can determines a first set of one or multiple reception occasion(s) for a downlink trigger, and/or determine a second set of one or multiple reception occasion(s) for at least one SSB in a set of SSB(s), and/or determine a third set of one or multiple reception occasion(s) for at least one PDCCH/PDSCH for SIB1 in the set of PDCCH(s)/PDSCH(s) for SIB1, wherein the second set and/or third set of reception occasion(s) locate after the first set of reception occasion(s), and the first set of reception occasion(s) locate after the transmission of the uplink request, and the UE may expect to receive the downlink trigger in the first set of reception occasion(s), and/or receive the at least one SSB in the set of SSB(s) in the second set of reception occasion(s), and/or receive the at least one PDCCH/PDSCH for SIB1 in the set of PDCCH(s)/PDSCH(s) for SIB1 in the third set of reception occasion(s).

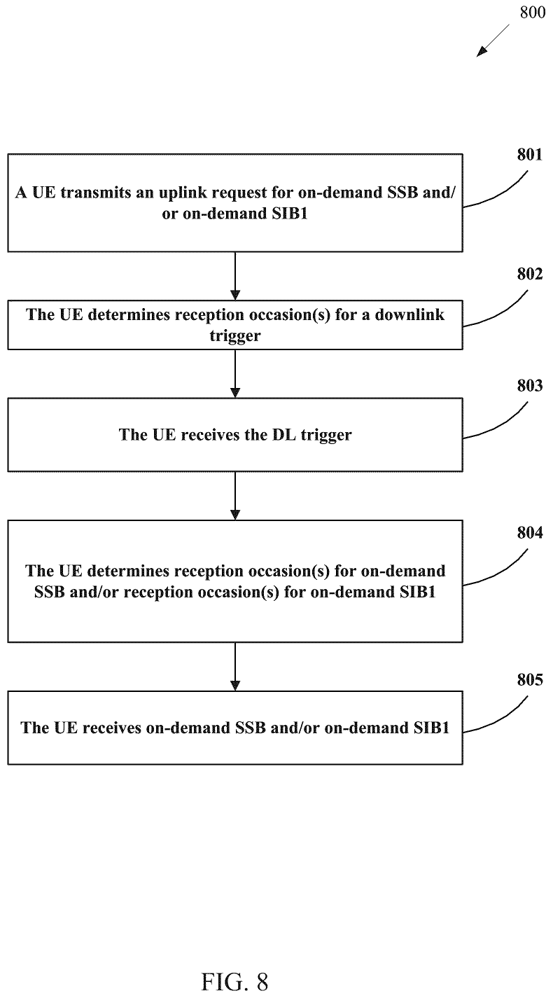

For this example, the reception of the downlink trigger and/or the reception of the at least one SSB in the set of SSB(s) and/or the reception of the at least one PDCCH/PDSCH for SIB1 in the set of PDCCH(s)/PDSCH(s) for SIB1 can be considered as a confirmation to the uplink request, and the UE may stop sending the uplink request again. For this example, if the UE did not receive the downlink trigger and/or the at least one SSB in the set of SSB(s) and/or the at least one PDCCH/PDSCH for SIB1 in the set of PDCCH(s)/PDSCH(s) for SIB1, e.g., in a window after the transmission of the uplink request, the UE may send the uplink request again at another transmission occasion for the uplink request or missing the reception for a number of times. An illustration of UE procedure for the example is shown in FIG. 8.

In yet another example (e.g., 704 in FIG. 7), a UE can determine a first set of one or multiple reception occasion(s) for at least one SSB in a set of SSB(s), and/or determine a second set of one or multiple reception occasion(s) for at least one PDCCH/PDSCH for SIB1 in the set of PDCCH(s)/PDSCH(s) for SIB1, and the UE may expect to receive the at least one SSB in the set of SSB(s) in the first set of reception occasion(s), and/or receive the at least one PDCCH/PDSCH for SIB1 in the set of PDCCH(s)/PDSCH(s) for SIB1 in the second set of reception occasion(s).

FIG. 8 illustrates a flowchart of UE method 800 for receiving on-demand SSB and/or on-demand SIB1 according to embodiments of the present disclosure. The UE method 800 as may be performed by a UE (e.g., 111-116 as illustrated in FIG. 1). An embodiment of the UE method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, in step 801, a UE transmits an uplink request for on-demand SSB and/or on-demand SIB1. In step 802, the UE determines reception occasion(s) for a downlink trigger. In step 803, the UE receives the DL trigger. In step 804, the UE determines reception occasion(s) for on-demand SSB and/or reception occasion(s) for on-demand SIB1. In step 805, the UE receives on-demand SSB and/or on-demand SIB1.

In one embodiment, an uplink signal or channel can be sent by a UE to request a set of SS/PBCH block(s) (e.g., on-demand SSB) and/or a set of PDCCH/PDSCH for SIB1 (e.g., on-demand SIB1). The uplink signal or channel can be denoted as uplink request, or uplink trigger, or uplink wake-up-signal (UL-WUS) in this disclosure.

In one example, the uplink request can be carried by an uplink physical layer (L1) signal or channel.

In one example, the uplink request can be carried by a physical random access channel (PRACH). A UE can be provided with a first set of configurations on a first set of PRACH occasions and a second set of configurations on a second set of PRACH occasions, wherein the first set of PRACH occasions and the second set of PRACH occasions may not overlap. The UE can use the first set of PRACH occasions for transmitting a PRACH for procedures other than carrying the information on requesting the on-demand SSB and/or SIB1, such as random access procedure, and use the second set of PRACH occasions for transmitting a PRACH carrying the information on requesting the on-demand SSB and/or SIB1. For instance, the first set of PRACH occasions can be for random access procedure, and the second set of PRACH occasions can be additional ones for transmitting a PRACH carrying the information on requesting the on-demand SSB and/or SIB1.

In another example, the uplink request can be carried by a physical random access channel (PRACH). A UE can be provided with a set of configurations on a set of PRACH occasions, wherein the PRACH occasions are shared for random access procedure or carrying the information on requesting the on-demand SSB and/or SIB1. A UE determines and transmits a first sequence in a first set of PRACH sequences when the PRACH occasion is for random access procedure, or determines and transmits a second sequence in a second set of PRACH sequences when the PRACH occasion is for carrying the information on requesting the on-demand SSB and/or SIB1, wherein the first set of sequences and the second type of sequences do not overlap. For instance, the first set of sequences can be for random access procedure, and the second set of sequences can be additional ones for transmitting a PRACH carrying the information on requesting the on-demand SSB and/or SIB1.

In yet another example, the uplink request can be carried by a scheduling request (SR). A UE can be provided with a set of configurations on the SR, wherein the SR can carry the information on requesting the on-demand SSB and/or SIB1. For one instance, the SR can be carried by a PUCCH, wherein the PUCCH can be transmitted on a PCell. For another instance, the SR can be carried by a PUCCH, wherein the PUCCH can be transmitted on a SCell or a PSCell (e.g., not the SCell or PSCell including the on-demand SSB or on-demand SIB1 transmission). For yet another instance, the SR can be carried by a PUSCH, wherein the PUSCH can be transmitted on a PCell. For yet another instance, the SR can be carried by a PUSCH, wherein the PUSCH can be transmitted on a SCell or a PSCell (e.g., not the SCell or PSCell including the on-demand SSB or on-demand SIB1 transmission). For yet another instance, the SR can be carried by a PUSCH, wherein the PUSCH can be transmitted on a combination of a PCell and a SCell or a PSCell (e.g., not the SCell or PSCell including the on-demand SSB or on-demand SIB1 transmission).

In yet another example, the uplink request can be carried by uplink control information (UCI). A UE can be provided with a set of configurations on the UCI, wherein the UCI can carry the information on requesting the on-demand SSB and/or SIB1. For one instance, the UCI can be carried by a PUCCH, wherein the PUCCH can be transmitted on a PCell. For another instance, the UCI can be carried by a PUCCH, wherein the PUCCH can be transmitted on a SCell or a PSCell (e.g., not the SCell or PSCell including the on-demand SSB or on-demand SIB1 transmission). For yet another instance, the UCI can be carried by a PUSCH, wherein the PUSCH can be transmitted on a PCell. For yet another instance, the UCI can be carried by a PUSCH, wherein the PUSCH can be transmitted on a SCell or a PSCell (e.g., not the SCell or PSCell including the on-demand SSB or on-demand SIB1 transmission). For yet another instance, the UCI can be carried by a PUSCH, wherein the PUSCH can be transmitted on a combination of a PCell and a SCell or a PSCell (e.g., not the SCell or PSCell including the on-demand SSB or on-demand SIB1 transmission).

In yet another example, the uplink request can be carried by MAC CE. A UE can be provided with a set of configurations on the MAC CE, wherein the MAC CE can carry the information on requesting the on-demand SSB and/or SIB1. For one instance, the MAC CE can be carried by a PUSCH, wherein the PUSCH can be transmitted on a PCell. For another instance, the MAC CE can be carried by a PUSCH, wherein the PUSCH can be transmitted on a SCell or a PSCell (e.g., not the SCell or PSCell including the on-demand SSB or on-demand SIB1 transmission). For yet another instance, the MAC CE can be carried by a PUSCH, wherein the PUSCH can be transmitted on a combination of a PCell and a SCell or a PSCell (e.g., not the SCell or PSCell including the on-demand SSB or on-demand SIB1 transmission).

In yet another example, the uplink request can be carried by a new signal or channel dedicated for requesting the on-demand SSB and/or SIB1.

In one embodiment, the uplink request can carry information on requesting the on-demand SSB and/or SIB1.

In one example, the information on requesting the on-demand SSB and/or SIB1 can include a request for on-demand SSB and SIB1 at the same time.

In another example, the information on requesting the on-demand SSB and/or SIB1 can include a first request for on-demand SSB and a second request on on-demand SIB1.

In one example, the information on requesting the on-demand SSB and/or SIB1 can include at least one QCL assumption and/or at least one TCI state that the on-demand SSB and/or SIB1 is associated with.

In one instance, the at least one QCL assumption and/or at least one TCI state can be explicitly indicated by the uplink request (e.g., represented by at least one SSB index or candidate SSB index).

In another instance, the at least one QCL assumption and/or at least one TCI state can be implicitly indicated by the location of the transmission occasion for the uplink request, e.g., the relative location of the transmission occasion within a set of transmission occasions.

In one example, the information on requesting the on-demand SSB and/or SIB1 can include a type of the on-demand SSB and/or SIB1, e.g., to be one from a periodic transmission, a semi-persistent transmission, or aperiodic transmission.

In one example, the information on requesting the on-demand SSB and/or SIB1 can include a type of the on-demand SSB, e.g., to be with a simplified structure (e.g., the number of symbols for the simplified structure is smaller than a legacy structure and/or the signal/channel included in the simplified structure is a subset from a legacy structure).

In one example, the information on requesting the on-demand SSB and/or SIB1 can include a periodicity for the transmission or reception of the on-demand SSB and/or SIB1.

In another example, the information on requesting the on-demand SSB and/or SIB1 can include time domain information (e.g., a time domain offset, or an absolute timing such as a frame or a half frame) for the transmission or reception of the on-demand SSB and/or SIB1.

For one instance, the time domain offset is defined with respect to a set of SS/PBCH blocks (e.g., transmitted periodically).

For another instance, the time domain offset is defined with respect to the uplink request.

For yet another instance, the time domain offset is defined with respect to an absolute timing, e.g., a start of a frame or a subframe or a slot in the period.

In yet another example, the information on requesting the on-demand SSB and/or SIB1 can include a time domain duration for the transmission or reception of the on-demand SSB and/or SIB1.

For one instance, the time domain duration can be determined as a number of transmission or reception occasions for the on-demand SSB and/or SIB1.

For another instance, the time domain duration can be determined as a number of repetitions for the on-demand SSB and/or SIB1.

For yet another instance, the time domain duration can be determined as a number of slots or half fames or frames that include the transmission or reception occasions for the on-demand SSB and/or SIB1.

In yet another example, the information on requesting the on-demand SSB and/or SIB1 can include a time domain pattern for the transmission or reception of the on-demand SSB and/or SIB1.

For one instance, the time domain pattern can be determined by a bitmap, e.g., the length of the bitmap equals to the maximum number of transmitted SSB in a period, and a bit in the bitmap corresponds to a SSB in the period.

In yet another example, the information on requesting the on-demand SSB and/or SIB1 can include a cell ID associated with the on-demand SSB and/or SIB1.

In yet another example, the information on requesting the on-demand SSB and/or SIB1 can include a frequency location associated with the on-demand SSB (e.g., the center RE location) and/or SIB1.

In yet another example, the information on requesting the on-demand SSB and/or SIB1 can include a transmission power associated with the on-demand SSB and/or SIB1.

In one embodiment, a UE can acquire a set of configurations for the uplink request.

In one example, the set of configurations include a periodicity for the transmission occasion(s) for the uplink request.

In another example, the set of configurations include time domain information (such as a time-domain offset, or an absolute timing) for the transmission occasion(s) for the uplink request.

In one instance, the time domain offset is with respect to a set of SS/PBCH blocks, e.g., which are periodically transmitted.

In another instance, the time domain offset is with respect to an absolute timing, e.g., a start of a first frame or subframe or slot within the periodicity.

In yet another example, the set of configurations include a duration for the transmission occasion(s) for the uplink request.

In one instance, the duration can be given by a number of transmission occasion(s), e.g., wherein the number of transmission occasion(s) can be equal to a number of transmitted SS/PBCH blocks.

In another instance, the duration can be given by a number of slots.

In yet another example, the set of configurations include a location of OFDM symbol(s) in a slot that includes the transmission occasion(s) for the uplink request.

In yet another example, the set of configurations include information on a frequency location for the transmission occasion(s) for the uplink request.

In one instance, the information on the frequency location can include a BWP that the transmission occasion(s) for the uplink request is located.

In another instance, the information on the frequency location can include a set of RBs that the transmission occasion(s) for the uplink request is located.

In yet another example, the set of configurations include information on a transmission power for the uplink request.

In one instance, the information on the transmission power can include a relative power for the uplink request comparing to a power reference (e.g., a SS/PBCH block, or another uplink signal or channel).

In one example, the set of configurations can be provided by the gNB that transmits the on-demand SSB and/or SIB1, e.g., by higher layer parameters.

In another example, the set of configurations can be provided by a second gNB or a second cell that may not transmit the on-demand SSB and/or SIB1 for the current gNB or current cell, while the UE can acquire higher layer parameters (e.g., SIB1 and/or other SIB and/or dedicated RRC parameters) from the second gNB or the second cell, and the set of configurations can be included in the higher layer parameters (e.g., SIB1 and/or other SIB and/or dedicated RRC parameters) from the second gNB.

In one embodiment, a UE can apply a delay (e.g., a time domain offset) after transmitting the uplink request.

For one example, the UE may not expect a reception of a downlink transmission (e.g., for confirming the transmission of the uplink request) and/or a set of SSB transmission (e.g., requested by the uplink request) within the delay.

For another example, the delay can be defined with respect to a timing reference. For one instance, the timing reference can be the start of the transmission of the uplink request. For another instance, the timing reference can be the end of the transmission of the uplink request.

For yet another example, the delay can be defined using a slot or an ODFM symbol as the unit.

For yet another example, the delay can be provided by a higher layer parameter.

For yet another example, the delay can be subject to a UE capability.

In one embodiment, a downlink signal or channel can be received by a UE before receiving a set of SS/PBCH block(s) (e.g., on-demand SSB) and/or a set of PDCCH/PDSCH for SIB1 (e.g., on-demand SIB1), or can be transmitted by a gNB before transmitting a set of SS/PBCH block(s) (e.g., on-demand SSB) and/or a set of PDCCH/PDSCH for SIB1 (e.g., on-demand SIB1). The downlink signal or channel indicating the transmission of on-demand SSB and/or on-demand SIB1 can be denoted as downlink trigger in this disclosure.

In one embodiment, the downlink trigger can be carried by a downlink physical layer (L1) signal or channel.

In one example, the downlink trigger can be carried by a physical downlink control channel (PDCCH).

For one instance, the downlink trigger can be included in a DCI format 2_0, e.g., by re-interpreting existing field in the DCI format and/or by using the reserved bits/fields in the DCI format.

For another instance, the downlink trigger can be included in a DCI format 2_6, e.g., by re-interpreting existing field in the DCI format and/or by using the reserved bits/fields in the DCI format.

For yet another instance, the downlink trigger can be included in a DCI format 2_7, e.g., by re-interpreting existing field in the DCI format and/or by using the reserved bits/fields in the DCI format.

For yet another instance, the downlink trigger can be included in a new DCI format, wherein the PDCCH carrying the DCI format is monitored in a common search space (CSS) set. For one instance, the new DCI format can be with CRC scrambled with a new RNTI. For another instance, the size of the new DCI format can be configured by a higher layer parameter.

In another example, the downlink trigger can be carried by a physical downlink shared channel (PDSCH).

For one instance, the downlink trigger can be included in system information (e.g., SIB1 or other SIB) carried by PDSCH.

For another instance, the downlink trigger can be included in MAC CE carried by a PDSCH. For one instance, the MAC CE can be carried by a PDSCH, wherein the PDSCH can be transmitted on a PCell. For another instance, the MAC CE can be carried by a PDSCH, wherein the PDSCH can be transmitted on a SCell or a PSCell (e.g., not the SCell or PSCell including the on-demand SSB or on-demand SIB1 transmission). For yet another instance, the MAC CE can be carried by a PDSCH, wherein the PDSCH can be transmitted on a combination of a PCell and a SCell or a PSCell (e.g., not the SCell or PSCell including the on-demand SSB or on-demand SIB1 transmission).

For yet another instance, the downlink trigger can be included in higher layer configuration (e.g., RRC parameter) carried by a PDSCH. For one instance, the higher layer configuration can be carried by a PDSCH, wherein the PDSCH can be transmitted on a PCell. For another instance, the higher layer configuration can be carried by a PDSCH, wherein the PDSCH can be transmitted on a SCell or a PSCell (e.g., not the SCell or PSCell including the on-demand SSB or on-demand SIB1 transmission). For yet another instance, the higher layer configuration can be carried by a PDSCH, wherein the PDSCH can be transmitted on a combination of a PCell and a SCell or a PSCell (e.g., not the SCell or PSCell including the on-demand SSB or on-demand SIB1 transmission).

In one embodiment, the downlink trigger can carry information on the on-demand SSB and/or SIB1.

In one example, the information on the on-demand SSB and/or SIB1 can include information on the on-demand SSB and on-demand SIB1 separately, e.g., for each of on-demand SSB and on-demand SIB1, the examples in this disclosure can apply.

In another example, the information on the on-demand SSB and/or SIB1 can include information on the on-demand SSB and on-demand SIB1 jointly.

In one example, the information on the on-demand SSB and/or SIB1 can include a type of the on-demand SSB and/or SIB1, e.g., to be one from a periodic transmission, a semi-persistent transmission, or aperiodic transmission.

In one example, the information on the on-demand SSB and/or SIB1 can include a type of the on-demand SSB, e.g., to be with a simplified structure (e.g., the number of symbols for the simplified structure is smaller than a legacy structure and/or the signal/channel included in the simplified structure is a subset from the legacy structure).

In one example, the information on the on-demand SSB and/or SIB1 can include at least one QCL assumption and/or at least one TCI state that the on-demand SSB and/or SIB1 is associated with.

In one instance, the at least one QCL assumption and/or at least one TCI state can be explicitly indicated by the downlink trigger (e.g., represented by at least one SSB index or candidate SSB index).

In another instance, the at least one QCL assumption and/or at least one TCI state can be implicitly indicated by the location of the reception occasion for the downlink trigger, e.g., the relative location of the reception occasion within a set of reception occasions.

In yet another instance, the at least one QCL assumption and/or at least one TCI state can be given by assuming the on-demand SSB and/or SIB1 is QCLed with the RS associated with the downlink trigger.

In one example, the information on the on-demand SSB and/or SIB1 can include a periodicity (e.g., a uniform time interval between neighboring transmissions or receptions) for the transmission or reception of the on-demand SSB and/or SIB1.

In another example, the information on the on-demand SSB and/or SIB1 can include time information (such as a time domain offset or an absolute timing such as a frame or a half frame) for the transmission or reception of the on-demand SSB and/or SIB1.

For one instance, the time domain offset is defined with respect to a set of SS/PBCH blocks (e.g., transmitted periodically).

For another instance, the time domain offset is defined with respect to the uplink request.

For yet another instance, the time domain offset is defined with respect to the downlink trigger.

For yet another instance, the time domain offset is defined with respect to an absolute timing, e.g., a start of a frame, or a half frame, or a subframe, or a slot in the period. For one further consideration, when the time offset is pre-determined as 0, then it is equivalent to provide an absolute timing as the start of the transmission or reception of the on-demand SSB and/or SIB1, wherein the absolute timing can be a start of a frame, or a half frame, or a subframe, or a slot in the period.

In yet another example, the information on the on-demand SSB and/or SIB1 can include a time domain duration for the transmission or reception of the on-demand SSB and/or SIB1.

For one instance, the time domain duration can be determined as a number of transmission or reception occasions or a number of bursts for the on-demand SSB and/or SIB1.

For another instance, the time domain duration can be determined as a number of repetitions for the on-demand SSB and/or SIB1.

For yet another instance, the time domain duration can be determined as a number of slots or half frames or frames that includes the transmission or reception occasions for the on-demand SSB and/or SIB1.

In yet another example, the information on the on-demand SSB and/or SIB1 can include a time domain pattern for the transmission or reception of the on-demand SSB and/or SIB1.

For one instance, the time domain pattern can be determined by a bitmap, e.g., the length of the bitmap equals to the maximum number of transmitted SSB in a period, and a bit in the bitmap corresponds to a SSB in the period.

In yet another example, the information on the on-demand SSB and/or SIB1 can include a cell ID associated with the on-demand SSB and/or SIB1.

In yet another example, the information on the on-demand SSB and/or SIB1 can include a frequency location associated with the on-demand SSB (e.g., the center RE location) and/or SIB1.

In yet another example, the information on the on-demand SSB and/or SIB1 can include a transmission power associated with the on-demand SSB and/or SIB1.

In one embodiment, a UE can acquire a set of configurations for the downlink trigger.

In one example, the set of configurations include a configuration for a CSS set to monitor the downlink trigger.

In one example, the set of configurations include a periodicity for the reception occasion(s) for the downlink trigger.

In another example, the set of configurations include a time-domain offset for the reception occasion(s) for the downlink trigger.

In one instance, the time domain offset is with respect to a set of SS/PBCH blocks, e.g., which are periodically transmitted.

In another instance, the time domain offset is with respect to an absolute timing, e.g., a start of a first frame or subframe or slot within the periodicity.

In yet another example, the set of configurations include a duration for the reception occasion(s) for the downlink trigger.

In one instance, the duration can be given by a number of reception occasion(s), e.g., wherein the number of reception occasion(s) can be equal to a number of transmitted SS/PBCH blocks.

In another instance, the duration can be given by a number of slots.

In yet another example, the set of configurations include a location of OFDM symbol(s) in a slot that includes the reception occasion(s) for the downlink trigger.

In yet another example, the set of configurations include information on a frequency location for the reception occasion(s) for the downlink trigger.

In one instance, the information on the frequency location can include a BWP that the reception occasion(s) for the downlink trigger is located.

In another instance, the information on the frequency location can include a set of RBs that the reception occasion(s) for the downlink trigger is located.

In yet another example, the set of configurations include information on a transmission power for the downlink trigger.

In one instance, the information on the transmission power can include a relative power for the downlink trigger comparing to a power reference (e.g., a SS/PBCH block, or another downlink signal or channel).

In one example, the set of configurations can be provided by the gNB that transmits the on-demand SSB and/or SIB1, e.g., by higher layer parameters.

In another example, the set of configurations can be provided by a second gNB or a second cell that may not transmit the on-demand SSB and/or SIB1, while the UE can acquire higher layer parameters (e.g., SIB1 and/or other SIB and/or dedicated RRC parameters) from the second gNB or the second cell, and the set of configurations can be included in the higher layer parameters (e.g., SIB1 and/or other SIB and/or dedicated RRC parameters) from the second gNB.

In one embodiment, a UE can apply a delay (e.g., a time domain offset) after receiving the downlink trigger.

For one example, the UE may not expect a reception of a set of SSB (e.g., the on-demand SSB) and/or SIB1 (e.g., the on-demand SIB1) within the delay.

For another example, the delay can be defined with respect to a timing reference. For one instance, the timing reference can be the start of the transmission of the uplink request. For another instance, the timing reference can be the end of the transmission of the uplink request. For yet another instance, the timing reference can be the start of the reception of the downlink trigger. For yet another instance, the timing reference can be the end of the reception of the downlink trigger.

For yet another example, the delay can be defined using a slot or an ODFM symbol as the unit.

For yet another example, the delay can be provided by a higher layer parameter or provided by the downlink trigger.

For yet another example, the delay (or its minimum value) can be subject to a UE capability.

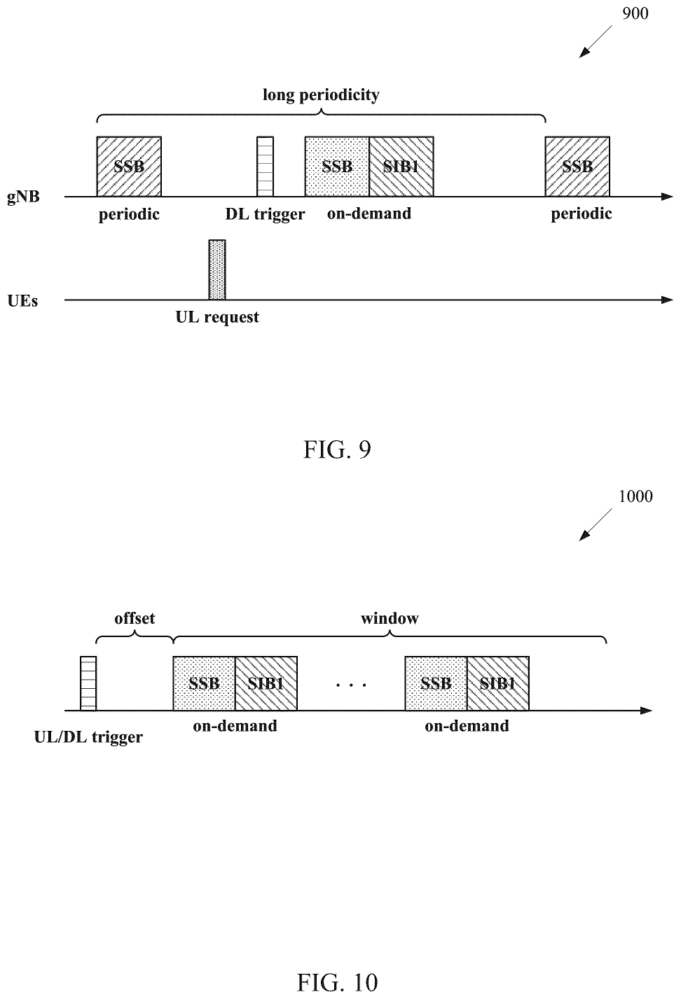

FIG. 9 illustrates an example of on-demand SSB/SIB1 900 according to embodiments of the present disclosure. An embodiment of the on-demand SSB/SIB1 900 shown in FIG. 9 is for illustration only.

As disclosed in the present disclosure, a UE can transmit an uplink request for on-demand SSB and/or SIB1, and the UE may receive a downlink trigger for the on-demand SSB and/or SIB1, before the reception of the on-demand SSB and/or SIB1. For this example, the procedure for uplink request and/or downlink trigger can be absent, in certain exemplified cases of this disclosure. An illustration of this example is shown in FIG. 9.

The present disclosure focuses on procedure for transmitting and receiving the on-demand transmission of SSB and/or SIB1. In details, this disclosure includes the following aspects: (1) a transmission window for on-demand SSB/SIB1: (i) a configuration for the transmission window, (ii) how to provide the configuration, and (iii) a transmission pattern within the transmission window; and (2) a unlicensed operation for the on-demand SSB/SIB1: (i) an impact to discovery burst definition, and (ii) an impact to discovery burst transmission window.

In one embodiment, a UE can transmit a set of SSB/SIB1 (e.g., on-demand SSB/SIB1) within at least one time domain window, wherein for example, the at least one time domain window locates after an uplink trigger and/or a downlink trigger, with a potential delay/offset. An illustration of this embodiment is shown in FIG. 10.

FIG. 10 illustrates an example of a transmission window for on-demand SSB/SIB1 1000 according to embodiments of the present disclosure. An embodiment of the transmission window for on-demand SSB/SIB1 1000 shown in FIG. 10 is for illustration only.

For one instance, the at least one time domain window for on-demand SSB/SIB1 transmission may not be explicitly defined, as described in the examples in this disclosure, e.g., the time domain window can be implicitly determined by a starting time instance and an ending time instance, wherein the starting time instance and/or the ending time instance can be according to examples of this disclosure.

In one embodiment, a UE can acquire a set of configurations for the on-demand SSB and/or on-demand SIB1.

For one example, the set of configurations can include configurations for the on-demand SSB and on-demand SIB1 jointly.

For another example, the set of configurations can include configurations for the on-demand SSB and on-demand SIB1 separately, e.g., for each of on-demand SSB and on-demand SIB1, the examples in this disclosure can apply.

For one example, the set of configurations can include a type of the on-demand SSB and/or SIB1, e.g., to be one from a periodic transmission, a semi-persistent transmission, or aperiodic transmission.

For one example, the set of configurations can include a type of the on-demand SSB, e.g., to be with a simplified structure (e.g., the number of symbols for the simplified structure is smaller than a legacy structure and/or the signal/channel included in the simplified structure is a subset from the legacy structure).

For one example, the set of configurations can include a periodicity for the transmission of the on-demand SSB and/or on-demand SIB1. For instance, this periodicity can be applicable to a periodic transmission and/or a semi-persistent transmission.

For one instance, when the on-demand SSB/SIB1 is transmitted periodically, the at least one window for the on-demand SSB/SIB1 transmission can occur periodically in the time domain with the periodicity.

For another instance, when the on-demand SSB/SIB1 is transmitted semi-persistently, the at least one window for the on-demand SSB/SIB1 transmission can occur periodically in the time domain with the periodicity, after a first uplink trigger or the downlink trigger to indicate the transmission of on-demand SSB/SIB1, and/or before a second uplink trigger or the downlink trigger to indicate stopping the transmission of on-demand SSB/SIB1.

For yet another instance, when the on-demand SSB/SIB1 is transmitted semi-persistently, the on-demand SSB/SIB1 burst(s) can occur periodically within the at least one window for the on-demand SSB/SIB1 transmission, e.g., after a first uplink trigger or the downlink trigger to indicate the transmission of on-demand SSB/SIB1, and/or before a second uplink trigger or the downlink trigger to indicate stopping the transmission of on-demand SSB/SIB1. For this instance, the periodicity can also be understood as an interval between neighboring transmission of the on-demand SSB/SIB1 bursts. For one further consideration, the unit of the periodicity (or interval in this instance) is a half frame (e.g., 5 ms) and the transmission of on-demand SSB/SIB1 is confined with a half frame.

For another example, the set of configurations can include timing information (e.g., a time domain offset or an absolute timing) for the transmission or reception of the on-demand SSB and/or SIB1. The UE can determine the start of transmission and/or reception of the on-demand SSB and/or SIB1 based on the timing information.

For one instance, the time domain offset is defined with respect to a set of SS/PBCH blocks (e.g., transmitted periodically).

For another instance, the time domain offset is defined with respect to the uplink request.

For yet another instance, the time domain offset is defined with respect to the downlink trigger.

For yet another instance, the time domain offset is defined with respect to an absolute timing, e.g., a start of a frame or a half frame or a subframe or a slot in the period. For instance, when the time domain offset is pre-determined as 0, the transmission or reception of the on-demand SSB and/or SIB1 can be assumed to start from the absolute timing, e.g., a start of a frame or a half frame or a subframe or a slot in the period.

For yet another instance, the time domain offset can be implicit, and determined based on the start of transmission and/or reception of the on-demand SSB and/or SIB1. For instance, the time domain offset corresponds to the difference between the timing of the uplink trigger and/or downlink trigger and the timing of the start of transmission of on-demand SSB/SIB1.

For yet another instance, the time domain offset can be implicit and determined based on a half frame including the candidate occasions for transmission and/or reception of a burst of the on-demand SSB and/or SIB1. For instance, the time domain offset corresponds to the difference between the timing of the uplink trigger and/or downlink trigger and the start of the half frame including the candidate occasions for transmission and/or reception of a burst of the on-demand SSB and/or SIB1. For another instance, the start of the half frame including the candidate occasions for transmission and/or reception of a burst of the on-demand SSB and/or SIB1 can be determined based on the DL or UL trigger applied with the time domain offset, e.g., the first half frame boundary after applying the time domain offset, and/or after the half frame including periodic SSB/SIB1.

In one example, a time domain offset can be determined with a minimum value (e.g., a minimum processing time). For one instance, the minimum value can be a UE capability and reported by the UE. For another instance, the minimum value can be pre-determined in the specification and potentially associated with a subcarrier spacing value. For yet another instance, the minimum value can be configured by the gNB.

For yet another example, the set of configurations can include a time domain duration for the transmission or reception of the on-demand SSB and/or SIB1. For one instance, the time domain duration can also be considered as a timer or a counter, such that the UE assumes the transmission and/or reception of the on-demand SSB and/or SIB1 occurs till the timer/counter expires.

For one instance, the time domain duration can be determined as a number of transmission or reception occasions or bursts for the on-demand SSB and/or SIB1.

For another instance, the time domain duration can be determined as a number of repetitions for the on-demand SSB and/or SIB1.

For yet another instance, the time domain duration can be determined as a number of frames, or half frames, or subframes, or slots that includes the transmission or reception occasions for the on-demand SSB and/or SIB1.

For yet another instance, the time domain duration can be determined as a number of SS/PBCH block bursts or a number of half frames that includes or may include the (candidate) transmission occasions for the SS/PBCH block bursts.

For yet another instance, the time duration can be determined based on a starting time instance which is determined by one example in this disclosure and an ending time instance which is determined by another example in this disclosure. For instance, the starting time instance is determined based on a first DL/UL trigger (e.g., indicating the transmission starts). For another instance, the ending time instance is determined based on a second DL/UL trigger (e.g., indicating the transmission ends).

For yet another example, the set of configurations can include a time domain pattern for the transmission or reception of the on-demand SSB and/or SIB1.

For one instance, the time domain pattern can be determined by a bitmap, e.g., the length of the bitmap equals to the maximum number of transmitted SSB in a period, and a bit in the bitmap corresponds to a SSB in the period. For one example, the indicated SSB index(es) are the same as or a subset of the indicated actually transmitted SSB index(es) by another bitmap (e.g., ssb-PositionsInBurst in system information or dedicated RRC, which is used for indicating the actually transmitted SSB index(es) for a periodic SSB in the same cell).

For another instance, the time domain pattern can be determined by a bitmap, e.g., the length of the bitmap equals to the number of actually transmitted SSB in a period (e.g., ssb-PositionsInBurst in system information or dedicated RRC), and a bit in the bitmap corresponds to an actually transmitted SSB in the period. The bit taking a value of 1 indicates the corresponding SSB is transmitted.

For yet another instance, the time domain pattern can be determined by two bitmaps, e.g., a first bitmap indicating SSB transmission in a group, and a second bitmap indicating SSB transmission of groups within a SSB burst. For one example, the indicated SSB index(es) are the same as or a subset of the indicated actually transmitted SSB index(es) by another bitmap (e.g., ssb-PositionsInBurst in system information or dedicated RRC, which is used for indicating the actually transmitted SSB index(es) for a periodic SSB in the same cell).

For yet another instance, the time domain pattern can be determined by two bitmaps, e.g., a first bitmap indicating SSB transmission in a group (number of groups corresponding to the number of groups for actually transmitted SSB), and a second bitmap indicating SSB transmission of groups within a SSB burst (number of groups corresponding to the number of actually transmitted groups within a SSB burst). For one example, the indicated SSB index(es) are the same as or a subset of the indicated actually transmitted SSB index(es) by another bitmap (e.g., ssb-PositionsInBurst in system information or dedicated RRC, which is used for indicating the actually transmitted SSB index(es) for a periodic SSB in the same cell).

For yet another instance, the time domain pattern can be determined by a bitmap, e.g., the length of the bitmap corresponds to a number of half frames potentially including the on-demand SSB/SIB1 transmission (e.g., a duration of the time domain window in the unit of half frames), and each bit in the bitmap indicates whether the corresponding half frame includes the actually transmitted on-demand SSB/SIB1 transmission.

For yet another example, the set of configurations can include a cell ID associated with the on-demand SSB and/or SIB1.

For yet another example, the set of configurations can include a subcarrier spacing of the on-demand SSB and/or SIB1.

For yet another example, the set of configurations can include a frequency location associated with the on-demand SSB (e.g., the center RE location) and/or SIB1 (e.g., the lowest RE or RB location). For one instance, the frequency location of the on-demand SSB/SIB1 is determined from a set of frequency values (e.g., sync raster entries). For another instance, the frequency location of the on-demand SSB/SIB1 is determined to be not from a set of frequency values (e.g., sync raster entries). For yet another instance, the frequency location of the on-demand SSB/SIB1 can be determined based on a frequency offset from the frequency location of the periodic SSB/SIB1 (e.g., periodic SSB/SIB1 and on-demand SSB/SIB1 are from the same cell, or periodic SSB/SIB1 are in the reference cell for the cell including the on-demand SSB/SIB1), wherein the frequency offset can be fixed or configured by higher layer parameters.

For yet another example, the set of configurations can include a transmission power or power offset associated with the on-demand SSB and/or SIB1. For one instance, the power offset between on-demand SSB/SIB1 and periodic SSB/SIB1 (e.g., periodic SSB/SIB1 and on-demand SSB/SIB1 are from the same cell, or periodic SSB/SIB1 are in the reference cell for the cell including the on-demand SSB/SIB1), which can be determined as EPRE difference between a signal in SSB e.g., PSS, SSS or DM-RS of PBCH.

For yet another example, the set of configurations can include an activation/deactivation command for the on-demand SSB and/or SIB1 transmission.

For yet another example, the set of configurations can include an enabling/disabling command for the on-demand SSB and/or SIB1 transmission.

For yet another example, the half frame(s) that include the on-demand SSB/SIB1 transmission do not overlap with the half frame(s) that include the periodic SSB/SIB1 transmission (e.g., periodic SSB/SIB1 and on-demand SSB/SIB1 are from the same cell, or periodic SSB/SIB1 are in the reference cell for the cell including the on-demand SSB/SIB1), such as, the transmission of on-demand SSB/SIB1 does not have collision with the transmission of periodic SSB/SIB1, or the transmission of on-demand SSB/SIB1 is on top of the transmission of periodic SSB/SIB1.

For yet another example, the symbol(s) that include the on-demand SSB/SIB1 transmission do not overlap with the symbol(s) that include the periodic SSB/SIB1 transmission (e.g., periodic SSB/SIB1 and on-demand SSB/SIB1 are from the same cell, or periodic SSB/SIB1 are in the reference cell for the cell including the on-demand SSB/SIB1), such as, the transmission of on-demand SSB/SIB1 does not have collision with the transmission of periodic SSB/SIB1, or the transmission of on-demand SSB/SIB1 is on top of the transmission of periodic SSB/SIB1.

In one embodiment, the UE can be provided with at least one parameter in the set of configurations for the on-demand SSB and/or SIB1 by a gNB.

For one example, at least one parameter in the set of configurations can be provided by the gNB that transmits the on-demand SSB and/or SIB1.

For one instance, at least one parameter in the set of configurations can be provided by higher layer parameters, e.g., SIB1, or other SIB, or dedicated RRC parameters (e.g., when the on-demand SSB is for SCell, the dedicated RRC parameter can be in the SCell configuration).

For another instance, at least one parameter in the set of configurations can be provided by the DL trigger that indicates the on-demand SSB/SIB1 transmission, which is transmitted by the gNB. When the at least one parameter in the set of configurations is provided by both higher layer parameters and the DL trigger, the indication by the DL trigger can override the indication by higher layer parameters.

For yet another instance, at least one parameter in the set of configurations can be provided by the UL trigger that indicates the on-demand SSB/SIB1 transmission, which is transmitted by the UE.

For another example, at least one parameter in the set of configurations can be provided by a second gNB that may not transmit the on-demand SSB and/or SIB1 in a cell of the current gNB, while the UE can acquire higher layer parameters (e.g., SIB1 and/or other SIB and/or dedicated RRC parameters) from the second gNB and at least one parameter in the set of configurations can be included in the higher layer parameters (e.g., SIB1 and/or other SIB and/or dedicated RRC parameters) from the second gNB.

In one examples, at least one parameter in the set of configurations can be included in both higher layer parameters and the DL trigger. In this case, the higher layer parameters can provide a set of candidate configurations for the at least one parameter (e.g., using a table or a subset of a table), and the DL trigger can indicate an index of the configuration from the set of candidate configurations.

In one example, at least one parameter in the set of configurations can be included in both higher layer parameters and the UL trigger. In this case, the higher layer parameters can provide a set of candidate configurations for the at least one parameter (e.g., using a table or a subset of a table), and the UL trigger can indicate an index of the configuration from the set of candidate configurations.

In one example, at least one parameter in the set of configurations can be included in both the UL trigger and the DL trigger. In this case, the at least one parameter in the DL trigger may override the one in the UL trigger.

For yet another example, at least one parameter in the set of configurations can be fixed or pre-determined in the specification. For one instance, the periodicity for the window can be fixed, e.g., 5 ms.

For another instance, the offset for the window can be fixed or pre-determined based on a condition.

For yet another instance, the duration for the window can be fixed or pre-determined based on a condition.

For yet another instance, the time domain pattern for the on-demand SSB/SIB1 can be fixed or pre-determined based on a condition, e.g., the time domain pattern for the on-demand SSB/SIB1 within a burst can be the same as the time domain pattern for periodic SSB/SIB1 within a burst (e.g., periodic SSB/SIB1 and on-demand SSB/SIB1 are from the same cell or same carrier, or periodic SSB/SIB1 are in the reference cell for the cell including the on-demand SSB/SIB1).

For yet another instance, the cell ID for the on-demand SSB/SIB1 can be fixed or pre-determined based on a condition, e.g., the cell ID for the on-demand SSB/SIB1 can be the same as the cell ID for periodic SSB/SIB1 (e.g., periodic SSB/SIB1 and on-demand SSB/SIB1 are from the same cell or same carrier, or periodic SSB/SIB1 are in the reference cell for the cell including the on-demand SSB/SIB1).

For yet another instance, the subcarrier spacing for the on-demand SSB/SIB1 can be fixed or pre-determined based on a condition, e.g., the subcarrier spacing for the on-demand SSB/SIB1 can be the same as the subcarrier spacing for periodic SSB/SIB1 (e.g., periodic SSB/SIB1 and on-demand SSB/SIB1 are from the same cell or same carrier, or periodic SSB/SIB1 are in the reference cell for the cell including the on-demand SSB/SIB1).

For yet another instance, the power offset for the on-demand SSB/SIB1 can be fixed or pre-determined based on a condition, e.g., the power for the on-demand SSB/SIB1 can be the same as the power for periodic SSB/SIB1 (e.g., periodic SSB/SIB1 and on-demand SSB/SIB1 are from the same cell or same carrier, or periodic SSB/SIB1 are in the reference cell for the cell including the on-demand SSB/SIB1), e.g., power offset is 0.

In one embodiment, a UE can be provided a first number M of on-demand SSB/SIB1, and a second number N of on-demand SSB/SIB1. For instance, M refers to a number of on-demand SSB/SIB1 in a burst, and N refers to a number of on-demand SSB/SIB1 bursts (or a number of repeated on-demand SSB/SIB1 transmission).

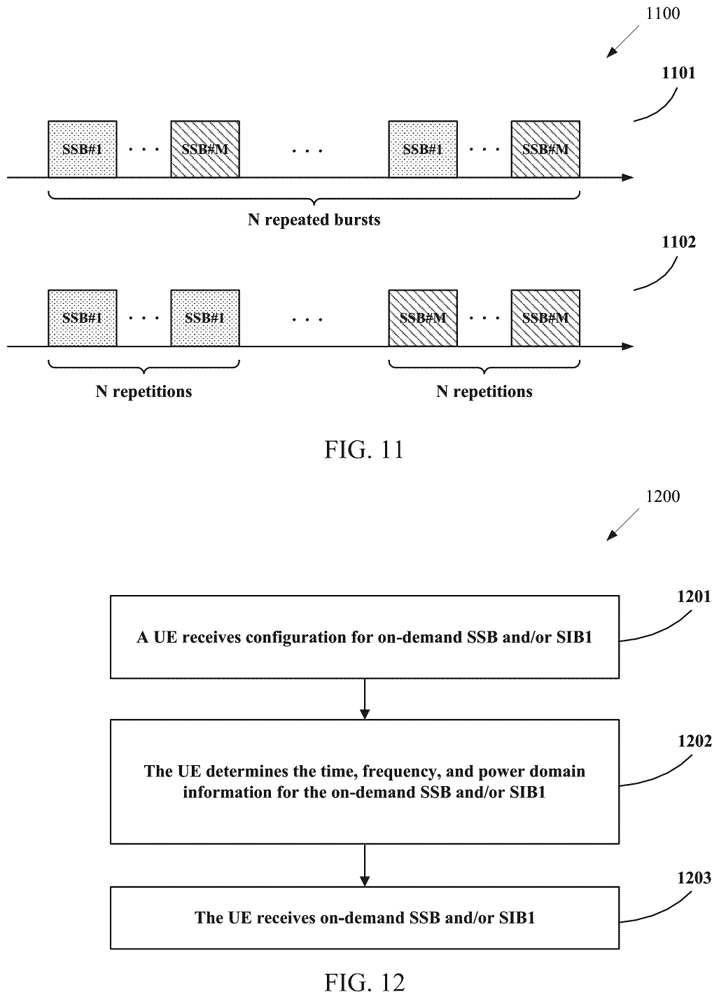

FIG. 11 illustrates an example of on-demand SSB/SIB1 transmissions 1100 according to embodiments of the present disclosure. An embodiment of the on-demand SSB/SIB1 transmissions 1100 shown in FIG. 11 is for illustration only.

For one example (e.g., 1101 in FIG. 11), the UE assumes the transmission of the on-demand SSB/SIB1 is performed first in a burst with M instances, then the bursts are repeated by N times. The m-th instance across different on-demand SSB/SIB1 bursts (e.g., the on-demand SSB/SIB1 corresponding to the same SSB index) are assumed to be QCLed, wherein in 1≤m<M. FIG. 11 illustrates the transmission pattern using SSB as an example, and the pattern is applicable for SIB1 transmission or multiplexed SSB and SIB1 transmission as well.

For another example (e.g., 1102 in FIG. 11), the UE assumes the transmission of the on-demand SSB/SIB1 is first repeated N times, and then performed in a burst with M instances. The repeated on-demand SSB/SIB1 (e.g., the on-demand SSB/SIB1 corresponding to the same SSB index) are assumed to be QCLed. FIG. 11 illustrates the transmission pattern using SSB as an example, and the pattern is applicable for SIB1 transmission or multiplexed SSB and SIB1 transmission as well.

For one example, both example transmission patterns (e.g., 1101 and 1102 in FIG. 11) can be supported, and subject to a configuration by the gNB, e.g., using a higher layer parameter, and/or by indication in the DL trigger, and/or by indication in the UL trigger.

For one example, the SSB transmission in a burst is within a half frame, and the transmission pattern within the half frame can be repeated in the transmission window, wherein the SSB(s) transmitted within each burst (or each half frame) are with the same indexes.

In one embodiment, on-demand SSB and/or SIB1 can be supported for operation with shared spectrum channel access.

For one example, on-demand SSB and/or SIB1 (e.g., including the PDCCH and PDSCH for the SIB1) can be included in a discovery burst.

For one instance, when the SSB and/or SIB1 (e.g., periodically transmitted) is included in a discovery burst, the on-demand SSB and/or SIB1 may not be included in the discovery burst.

For another instance, when on-demand SSB and/or SIB1 is included in a discovery burst, the SSB and/or SIB1 (e.g., periodically transmitted) may not be included in the discovery burst.

In one instance, the duty cycle of the discovery burst (e.g., on-demand SSB and/or SIB1) can be defined as D_2/P_2, wherein D_2 is the duration of the transmission for the on-demand SSB and/or SIB1 that is included in the discovery burst, and P_2 is an observation duration for calculating the duty cycle (e.g., P_2 can be fixed as a number of frames such as 160 ms).

In another instance, the duty cycle of the discovery burst (e.g., on-demand SSB and/or SIB1) can be defined as D_2/P_2, wherein D_2 is the duration of the transmission for the on-demand SSB and/or SIB1 that is included in the discovery burst, and P_2 is the periodicity of the on-demand SSB and/or SIB1 (e.g., when on-demand SSB and/or SIB1 is periodically transmitted).

In yet another instance, the duty cycle of the discovery burst (e.g., on-demand SSB and/or SIB1) can be defined as N*D_2/P_2, wherein D_2 is the duration of the transmission for the on-demand SSB and/or SIB1 that is included in the discovery burst, and P_2 is an observation duration for calculating the duty cycle (e.g., P_2 can be fixed as a number of frames such as 160 ms), and N is the number of repetitions.

For yet another instance, when the SSB and/or SIB1 (e.g., periodically transmitted) is included in a discovery burst, the on-demand SSB and/or SIB1 can be included in the discovery burst when it's periodically transmitted.

In one instance, assuming the periodicity of SSB and/or SIB1 in a discovery burst is P_1, and duration of the SSB and/or SIB1 is D_1; and assuming the periodicity of the on-demand SSB and/or SIB1 in a discovery burst is P_2, and duration of the on-demand SSB and/or SIB1 is D_2; then the duty cycle of the discovery burst can be defined as (D_1*P/P_1+D_2*P/P_2)/P, wherein P=max (P_1, P_2).

For yet another instance, when the SSB and/or SIB1 (e.g., periodically transmitted) is included in a discovery burst, the on-demand SSB and/or SIB1 can also be included in the discovery burst.

In one instance, assuming the periodicity of SSB and/or SIB1 in a discovery burst is P_1, and duration of the SSB and/or SIB1 is D_1; and assuming the transmission of on-demand SSB and/or SIB1 is periodic, and the periodicity of the on-demand SSB and/or SIB1 in a discovery burst is P_2, and duration of the on-demand SSB and/or SIB1 is D_2; then the duty cycle of the discovery burst can be defined as (D_1*P/P_1+D_2*P/P_2)/P, wherein P=max (P_1, P_2).

In another instance, assuming the periodicity of SSB and/or SIB1 in a discovery burst is P_1, and duration of the SSB and/or SIB1 is D_1; and assuming the transmission of on-demand SSB and/or SIB1 is not periodic (e.g., aperiodic and/or semi-persistent), and the duration of the on-demand SSB and/or SIB1 is D_2; then the duty cycle of the discovery burst can be defined as (D_1*P/P_1+D_2*N)/P, wherein P is the observation period for calculating the duty cycle (e.g., P can be fixed as a number of frames such as 160 ms), and N is the number of repetitions within P.

For one instance, a Type 2A channel access procedure can be applicable to transmission(s) initiated by a gNB, wherein the transmission(s) include discovery burst only or discovery burst multiplexed with non-unicast information, and the transmission duration is at most 1 ms, and the duty cycle of the discovery burst is at most 1/20. In this example, Type 2A channel access procedure refers to the procedure that a gNB may transmit a downlink transmission immediately after sensing the channel to be idle for at least a sensing interval of 25 us.

For another instance, a Type 1 channel access procedure can be applicable to transmission(s) initiated by a gNB, wherein the transmission(s) may include discovery burst or discovery burst multiplexed with non-unicast information. In this example, Type 1 channel access procedure refers to the procedure that a gNB may transmit a downlink transmission after sensing the channel to be idle for a time duration spanned by the sensing slots, wherein the number of sensing slots is random (e.g., based on a random counter).

For another example, on-demand SSB and/or SIB1 (e.g., including the PDCCH and PDSCH for the SIB1) cannot be included in a discovery burst.

For one instance, only Type 1 channel access procedure can be applicable to transmission(s) initiated by a gNB, when the transmission(s) may include on-demand SSB and/or on-demand SIB1. In this example, Type 1 channel access procedure refers to the procedure that a gNB may transmit a downlink transmission after sensing the channel to be idle for a time duration spanned by the sensing slots, wherein the number of sensing slots is random (e.g., based on a random counter).

In one example, the SS/PBCH blocks in a serving cell that are within a same transmission window or across transmission windows are QCLed, if a value of (N_{DM-RS}^{PDCH} mod N_{SSB}^{QCL}) is same among the SS/PBCH blocks, wherein N_{DM-RS}^{PDCH} is an index of a DM-RS sequence transmitted in a PBCH of a corresponding SS/PBCH block, and N_{SSB}^{QCL} is either provided by ssb-PositionQCL or, if ssb-PositionQCL is not provided, obtained from a MIB. For one example, this example can be applicable if there is a limitation that a transmission window may not exceed half frame.

In another example, the SS/PBCH blocks in a serving cell that are within a same transmission window or across transmission windows are QCLed, if a value of (k mod N_{SSB}^{QCL}) is same among the SS/PBCH blocks, wherein k is an index of a candidate SSB within the transmission window, and N_{SSB}^{QCL} is either provided by ssb-PositionQCL or, if ssb-PositionQCL is not provided, obtained from a MIB. For this example, the index of candidate SSB in the transmission window starts from 0, and when the transmission window exceeds a half frame, the candidate SSB may keep on indexing instead of re-indexing from 0.

FIG. 12 illustrates a flowchart of UE method 1200 for on-demand SSB/SIB1 reception according to embodiments of the present disclosure. The UE method 1200 as may be performed by a UE (e.g., 111-116 as illustrated in FIG. 1). An embodiment of the UE method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, in step 1201, a UE receives configuration for on-demand SSB and/or SIB1. In step 1202, the UE determines the time, frequency, and power domain information for the on-demand SSB and/or SIB1. In step 1203, the UE receives on-demand SSB and/or SIB1.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a first physical downlink shared channel (PDSCH) from a base station (BS); and
a processor operably coupled to the transceiver, the processor configured to:
determine, based on an indication in the first PDSCH, that a set of synchronization signals and physical broadcast channel (SS/PBCH) blocks is activated for transmission from the BS;
determine a time domain offset with respect to the first PDSCH; and
determine that the set of SS/PBCH blocks is to be transmitted after the time domain offset,
wherein the transceiver is further configured to receive a SS/PBCH block in the set of SS/PBCH blocks.

2. The UE of claim 1, wherein:
the UE is in RRC_CONNECTED state, and
the set of SS/PBCH blocks is to be transmitted in a secondary cell (SCell).

3. The UE of claim 1, wherein the first PDSCH includes one of 1) a medium access control (MAC) control element (CE) or 2) radio resource control (RRC) parameters.

4. The UE of claim 1, wherein the set of SS/PBCH blocks is to be transmitted within a time domain window.

5. The UE of claim 4, wherein:
a starting instance of the time domain window is determined based the first PDSCH; and
an ending instance of the time domain window is determined based on one of:
a second PDSCH, wherein the second PDSCH includes an indication that the transmission of the set of SS/PBCH blocks is deactivated;
a counter corresponding to a number of SS/PBCH block bursts in the set of SS/PBCH blocks; or
a duration of the time domain window.

6. The UE of claim 4, wherein:
the set of SS/PBCH blocks are transmitted periodically within the time domain window, and
an interval between two neighboring SS/PBCH block bursts is provided by a radio resource control (RRC) parameter.

7. The UE of claim 1, wherein:
the transceiver is further configured to receive radio resource control (RRC) parameters, and
the RRC parameters include:
a cell identity (ID) for the set of SS/PBCH blocks;
a bitmap indicating a time domain pattern for the set of SS/PBCH blocks;
a frequency location for the set of SS/PBCH blocks; or
a transmission power for the set of SS/PBCH blocks.

8. A method of a user equipment (UE) in a wireless communication system, the method comprising:
receiving a first physical downlink shared channel (PDSCH) from a base station (BS);
determining, based on an indication in the first PDSCH, that a set of synchronization signals and physical broadcast channel (SS/PBCH) blocks is activated for transmission from the BS;
determining a time domain offset with respect to the first PDSCH;
determining that the set of SS/PBCH blocks is to be transmitted after the time domain offset; and
receiving a SS/PBCH block in the set of SS/PBCH blocks.

9. The method of claim 8, wherein:
the UE is in RRC_CONNECTED state, and
the set of SS/PBCH blocks is to be transmitted in a secondary cell (SCell).

10. The method of claim 8, wherein the first PDSCH includes one of 1) a medium access control (MAC) control element (CE) or 2) radio resource control (RRC) parameters.

11. The method of claim 8, wherein the set of SS/PBCH blocks is to be transmitted within a time domain window.

12. The method of claim 11, wherein:
a starting instance of the time domain window is determined based the first PDSCH; and
an ending instance of the time domain window is determined based on one of:
a second PDSCH, wherein the second PDSCH includes an indication that the transmission of the set of SS/PBCH blocks is deactivated;
a counter corresponding to a number of SS/PBCH block bursts in the set of SS/PBCH blocks; or
a duration of the time domain window.

13. The method of claim 11, wherein:
the set of SS/PBCH blocks are transmitted periodically within the time domain window, and
an interval between two neighboring SS/PBCH block bursts is provided by a radio resource control (RRC) parameter.

14. The method of claim 8 further comprising:
receiving radio resource control (RRC) parameters, wherein the RRC parameters include:
a cell identity (ID) for the set of SS/PBCH blocks;
a bitmap indicating a time domain pattern for the set of SS/PBCH blocks;
a frequency location for the set of SS/PBCH blocks; or
a transmission power for the set of SS/PBCH blocks.

15. A base station (BS) in a wireless communication system, the BS comprising:
a processor configured to:
determine an indication in a first physical downlink shared channel (PDSCH), wherein the indication indicates that a set of synchronization signals and physical broadcast channel (SS/PBCH) blocks is activated for transmission; and
determine a time domain offset with respect to the first PDSCH; and
a transceiver operably coupled to the processor, the transceiver configured to:
transmit the first PDSCH to a user equipment (UE); and
transmit the set of SS/PBCH blocks after the time domain offset.

16. The BS of claim 15, wherein:
the UE is in RRC_CONNECTED state, and
the set of SS/PBCH blocks is transmitted in a secondary cell (SCell).

17. The BS of claim 15, wherein the first PDSCH includes one of 1) a medium access control (MAC) control element (CE) or 2) radio resource control (RRC) parameters.

18. The BS of claim 15, wherein the set of SS/PBCH blocks is transmitted within a time domain window.

19. The BS of claim 18, wherein:
a starting instance of the time domain window is determined based the first PDSCH;
an ending instance of the time domain window is determined based on one of:
a second PDSCH, wherein the second PDSCH includes an indication that the transmission of the set of SS/PBCH blocks is deactivated;
a counter corresponding to a number of SS/PBCH block bursts in the set of SS/PBCH blocks; or
a duration of the time domain window;
the set of SS/PBCH blocks are transmitted periodically within the time domain window; and
an interval between two neighboring SS/PBCH block bursts is provided by a radio resource control (RRC) parameter.

20. The BS of claim 15 wherein:
the transceiver is further configured to transmit radio resource control (RRC) parameters, and
the RRC parameters include:
a cell identity (ID) for the set of SS/PBCH blocks;
a bitmap indicating a time domain pattern for the set of SS/PBCH blocks;
a frequency location for the set of SS/PBCH blocks; or
a transmission power for the set of SS/PBCH blocks.
